(19) United States
(12) Patent Application Publication
(10) Pub. No.: US 2013/0086072 A1
(43) Pub. Date: Apr. 4, 2013

(54) METHOD AND SYSTEM FOR EXTRACTING AND CLASSIFYING GEOLOCATION INFORMATION UTILIZING ELECTRONIC SOCIAL MEDIA

(71) Applicants: Wei Peng, Fremont, CA (US); Anuj Jaiswal, State College, PA (US); Tong Sun, Penfield, NY (US); Matthew DeRoller, Webster, NY (US)

(72) Inventors: Wei Peng, Fremont, CA (US); Anuj Jaiswal, State College, PA (US); Tong Sun, Penfield, NY (US); Matthew DeRoller, Webster, NY (US)

(73) Assignee: XEROX CORPORATION, Norwalk, CT (US)

(21) Appl. No.: 13/251,731

(22) Filed: Oct. 3, 2011

(51) Int. Cl. G06F 17/30

(52) U.S. Cl. 707/743; 707/754; 707/E17.11; 707/E17.018

(57) ABSTRACT

Methods, systems and processor-readable media for extracting and classifying location information utilizing social media messages and/or data thereof. The social media messages can be sampled from a social media database and the messages filtered based on a heuristic rule. A geolocation entity from the unstructured social media messages can be extracted utilizing a geolocation entity extracting module. The messages with the geoentities can be uploaded onto a crowd sourcing platform to manually annotate the messages with a label. A text classification model can be built and learned from the label utilizing a machine learning algorithm and the messages can be classified by a location classifier in order to extract the user location. The user location can then be transformed into a geocode so that a spatial search can be enabled and the distance between the locations can be easily calculated.

### TECHNICAL FIELD

Embodiments are generally related to electronic social media. Embodiments are additionally related to geolocation information extraction techniques. Embodiments are further related to the extraction of user geolocation information utilizing social media data, such as social media messaging.

### BACKGROUND OF THE INVENTION

Social media generally involves a large number of users who interact socially with one another in a networked electronic environment such as the “Internet”. In such a paradigm, social media users can freely express and share opinions with other users via a social networking application. Social media encompasses online media such as, for example, collaborative projects (e.g. Wikipedia), blogs and microblogs (e.g. Twitter), content communities (e.g. YouTube), social networking sites (e.g. Facebook), virtual game worlds (e.g. World of Warcraft), and virtual social worlds (e.g. Second Life).

In the context of such electronic social media, Enterprise Marketing Services (EMS) can be utilized to deliver personalized content to a broad customer base in accordance with particular user profile information with the immediate goal of improving the response rate. Social media marketing, which employs social network data to benefit the enterprise and an individual with additional marketing channel, has recently gained more traction.

Social media users generally share location information via explicit location sharing and implicit location sharing. FIG. 1 illustrates a table 10 representing a comparison between social media geolocations. Explicit location sharing can be, for example, a user profile location 20 and a user check-in location 30. Implicit location sharing can include, for example, a user message content location 40. The user profile location 20 generally includes the location posted by the user on the social network profile. The user check-in location 30 can include the use of location data posted from, for example, a GPS-activated mobile client. The user content location 40 represents the locations embedded in a user status update.

Current social media monitoring tools employ explicit user location sharing, as the user location can be easily viewed and accessed via crawling social network metadata. Such an approach does not, however, utilize implicit user location sharing as it is not easy to differentiate the user locations and the generation locations (e.g. location name in a weather forecast) from social media messages because such operations are performed by machines without human understanding. For example, users close to a particular location can be determined by considering the user profile location 20 and the user check-in location 30 for a realtime local service (e.g. shopping store or restaurant) recommendation. A location-based service recommendation and travel related business, however, requires that user content locations 40 indicate the future location of the user which is much more difficult to identify when compared to the explicit user locations. Additionally, current techniques do not analyze the content of the messages and do not track user temporary locations. Furthermore, it is difficult to detect the locations from a single message and real-time current and future locations.

Based on foregoing, it is believed that a need exists for an improved system and method for extracting and classifying user geolocation information utilizing a social media message, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved method and system for extracting and classifying user geolocation information utilizing social media messages and/or data thereof.

It is another aspect of the disclosed embodiments to provide for an improved method and system for sampling and filtering the social media messages.

It is a further aspect of the disclosed embodiments to provide for an improved method and system for extracting geoentity from social media messages and learning a text classification model from a label manually annotated with messages.

The aforementioned aspects and other objectives and advantages can now be achieved as described herein. Methods and systems for extracting and classifying location information utilizing social media messages are disclosed herein. Social media messages can be sampled from a social media database and the messages filtered based on a heuristic rule. A geolocation entity from unstructured social media messages can be extracted utilizing a geolocation entity-extracting module. The messages with the geoentities can be uploaded onto a crowd sourcing platform (e.g., Amazon Mechanical Turk (AMT)) to manually annotate the messages with a label. A text classification model can be constructed and “learned” from the label utilizing a machine-learning algorithm. Additionally, messages can be classified by a location classifier in order to extract user location. The user location can then be transformed into a geocode so that a spatial search is enabled. Then, the distance between the locations can be easily calculated.

Social media messages can be filtered via a heuristic message-filtering module in order to obtain a large number of user location messages, reduce “noisy” data, and render human annotation efforts more effective. The percentage of user location messages in the labeled training data increases dramatically after the filtering process. The geo-entity extraction can be performed utilizing, for example, a geographical dictionary (e.g., gazetteer) or a linguistic rule (e.g. a part of speech).

The machine-learning module identifies the user location message and categorizes the user location message into “past”, “current”, and “future” classes. The classification algorithm such as, for example, maximum entropy, Naive Bayes, and support vector machine can be employed to achieve better performance and efficient testing. Masking the locations, including bi-grams, not removing a stop word, and feature selection utilizing information gain, can generate the text feature for the location classification. Such user geolocation information can be utilized to assist, for example, an enterprise marketing service and customer relationship management to understand location-related customer interests and sentiments for effective marketing and customer services.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a table representing the comparison between social media geolocations;

FIG. 2 illustrates a schematic view of a computer system, in accordance with the disclosed embodiments;

FIG. 3 illustrates a schematic view of a software system including a geolocation extraction and classification module, an operating system, and a user interface, in accordance with the disclosed embodiments;

FIG. 4 illustrates a block diagram of a geolocation extraction system, in accordance with the disclosed embodiments;

FIG. 5 illustrates a high-level flow chart of operations illustrating logical operational steps of a method for extracting and classifying user geolocation information utilizing social media messages, in accordance with the disclosed embodiments.

FIGS. 6-7 illustrate a graph depicting data indicative of AMT labels with respect to the user location identification, in accordance with an exemplary embodiment;

FIG. 8 illustrates a table representing the classification performance with respect to the user location messages identification, in accordance, with an exemplary embodiment;

FIG. 9 illustrates a graph depicting data indicative of AMT labels with respect to the user location categorization, in accordance with an exemplary embodiment;

FIG. 10 illustrates a table representing classification performance with respect to the user location messages categorization, in accordance with an exemplary embodiment; and

FIGS. 11-12 illustrate a table representing precision and recall of the current location identification and future location identification, in accordance with an exemplary embodiment.

### DETAILED DESCRIPTION

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet utilizing an Internet Service Provider).

The disclosed embodiments are described in part below with reference to flowchart illustrations and/or block diagrams of methods, systems, and computer program products, data structures, and other processor-readable media. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program (e.g., processor-readable media) instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Although not required, the disclosed embodiments will be described in the general context of computer-executable instructions such as program modules being executed by a single computer. In most instances, a “module” constitutes a software application. Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

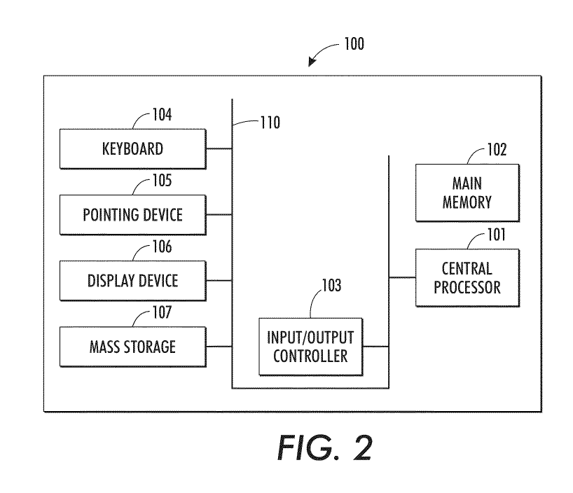

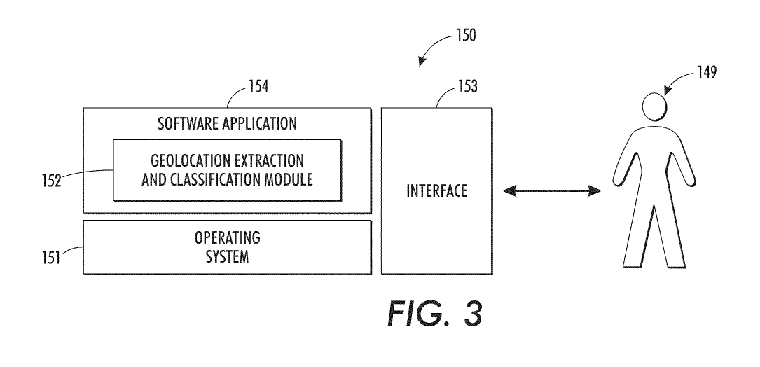

FIGS. 2-3 are provided as exemplary diagrams of data-processing environments in which embodiments of the present invention may be implemented. It should be appreciated that FIGS. 2-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 2, the disclosed embodiments may be implemented in the context of a data-processing system 100 that includes, for example, a central processor 101, a main memory 102, an input/output controller 103, a keyboard 104, pointing device 105 (e.g., an input device such as a mouse, track ball, and pen device, etc.), a display device 106, a mass storage 107 (e.g., a hard disk), and, for example, a USB (Universal Serial Bus) peripheral connection (not shown). As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 3 illustrates a computer software system 150 for directing the operation of the data-processing system 100 depicted in FIG. 2. Software application 154, stored in main memory 102 and on mass storage 107, generally includes a kernel or operating system 151 and a shell or interface 153. One or more application programs, such as software application 152, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 152 and/or software application 154.

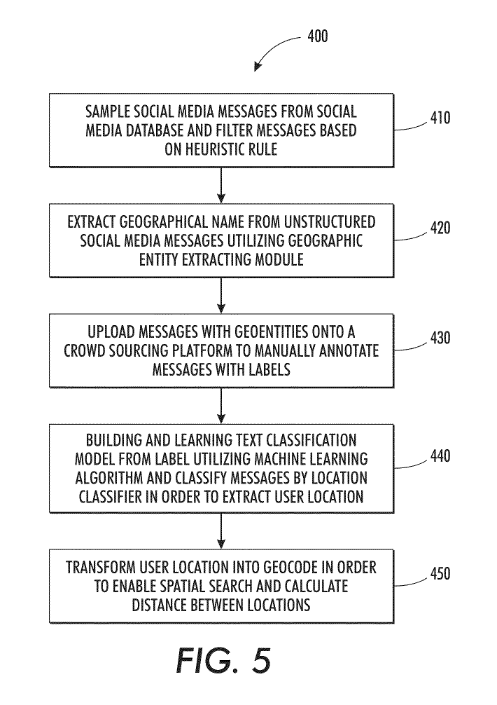

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include a user geolocation identification and classification module 152 for extracting and classifying geolocation information utilizing social media messages. Software application 154, on the other hand, can include instructions such as the various operations described herein with respect to the various components and modules described herein such as, for example, the method 400 depicted in FIG. 5.

FIGS. 2-3 are thus intended as examples and not as architectural limitations of the disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

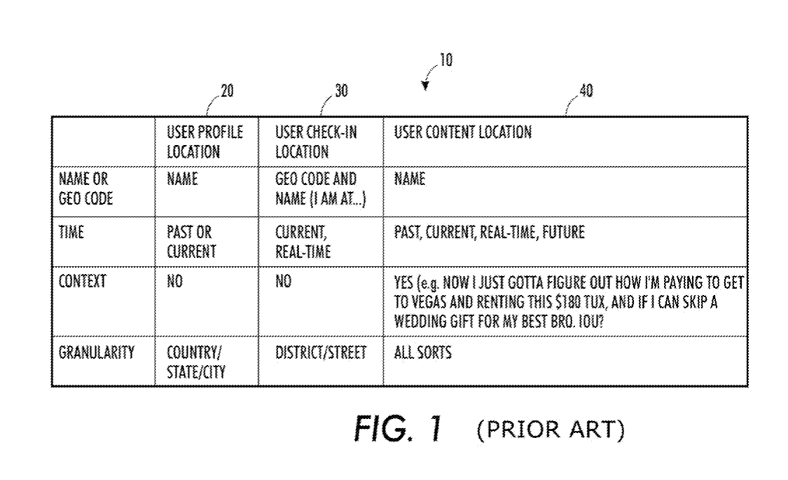

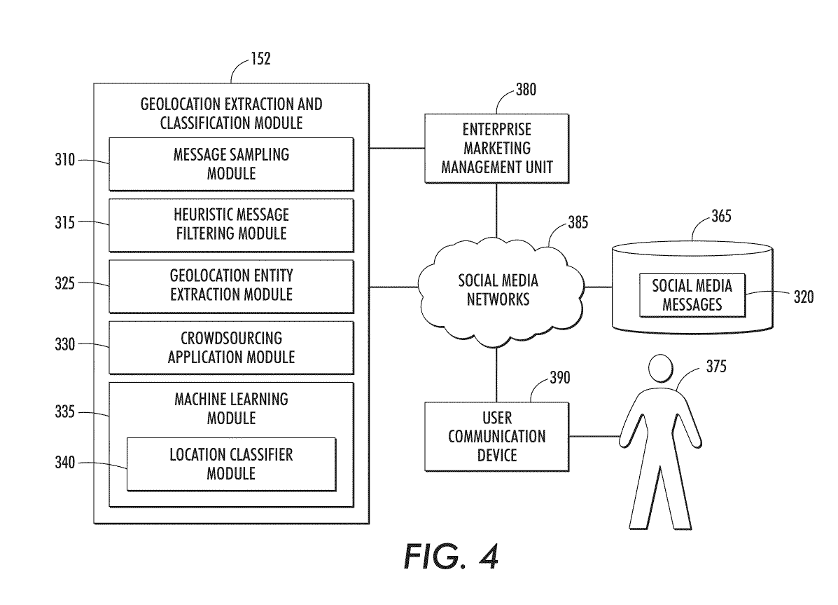

FIG. 4 illustrates a block diagram of a geolocation extraction system, in accordance with the disclosed embodiments. Note that in FIGS. 1-12, identical parts or elements are generally indicated by identical reference numerals. The social media networks 385 can be configured to the geolocation extraction and classification module 152 to extract and classify geolocation information with respect to a user 375 utilizing social media messages 320 in a social media environment. In general, geolocation represents the identification of the real-world geographic location of an object such as radar, mobile phone or an Internet-connected computer terminal. Geolocation may refer to the practice of assessing the location, or to the actual assessed location. The social media networks 385 can be any social media including, but not limited to, networks, websites, or computer enabled systems. For example, a social media network may be MySpace, Facebook, Twitter, Linked-In, Spoke, or other similar computer enabled systems or websites. A user communication device 390 can communicate with the social media networks 385. Note that the user communication device 390 can be, for example, a mobile communication device, a data-processing system, and a web-enabled device, depending upon design considerations.

The geolocation extraction system can be employed to assist the enterprise marketing services and customer relationship management unit 380 to understand location related customer interest and sentiment for effective marketing services and customer services. The geolocation extraction system can also be used for location-based service recommendation, user privacy monitoring, and travel related business. The social media networks 385 can communicate with the enterprise marketing management unit 380, which in turn can communicate with the user communication device 390.

In general, enterprise marketing management defines a category of software used by marketing operations to manage their end-to-end internal processes. Enterprise marketing management is a subset of marketing technologies which consists of a total of 3 key technology types that allow for corporations and customers to participate in a holistic and real-time marketing campaign. Enterprise marketing management consists of other marketing software categories such as web analytics, campaign management, digital asset management, web content management, marketing resource management, marketing dashboards, lead management, event-driven marketing, predictive modeling, and more.

The geolocation extraction and classification module 152 includes a message sampling module 310, a heuristic message filtering module 315, a geolocation entity extraction module 325, a crowdsourcing application module 330, and a machine learning module 335. The message sampling module 310 samples the social media message(s) 320 (e.g., one or more messages) from a social media database 365 and the heuristic message filtering module 315 filters the messages 320 based on a heuristic rule. The heuristic rule is a commonsense rule (or set of rules) intended to increase the probability of solving some problem. The geographic entity extracting module 325 extracts the geolocation entity from the unstructured social media messages 320.

The crowdsourcing application module 330 uploads the messages with the geoentities onto a crowd sourcing platform (e.g., Amazon Mechanical Turk (AMT)) to manually annotate the messages with a label. The Amazon Mechanical Turk is a crowdsourcing Internet marketplace that enables computer programmers (known as Requesters) to co-ordinate the use of human intelligence to perform tasks that computers are unable to do yet. The machine learning module 335 performs a machine learning technique to learn a text classification model from the human labels. Finally, the messages can be classified by a location classifier module 340 in order to extract the user location. The user location can then be transformed into a geocode so that spatial search can be enabled and the distance between the locations can be easily calculated. Geocode (Geospatial Entity Object Code) is a standardized all-natural number representation format specification for geospatial coordinate measurements that provide details of the exact location of geospatial point at, below, or above the surface of the earth at a specified moment of time.

The messages 320 can be filtered via the heuristic message filtering module 315 in order to obtain enough percentage of the user location messages in the training data, reduce noisy data, and make human annotation efforts more effective. The percentage of the user location messages in the training data increases dramatically after the filtering process by the heuristic message filtering module 315. The geo-entity extraction can be performed by utilizing gazetteers (e.g., dictionary lookup) or a linguistic rule (e.g., part of speech). A gazetteer is a geographical dictionary or directory, an important reference for information about places and place names (see: toponymy) used in conjunction with a map or a full atlas. It typically contains information concerning the geographical makeup of a country, region, or continent as well as the social statistics and physical features such as mountains, waterways, or roads.

The machine learning module 335 identifies the user location message and categorizes the user location message into “past”, “current”, and “future” classes. The classification algorithm such as, for example, maximum entropy, Naive Bayes, and SVM can be employed to achieve better performance and efficient testing. The text feature for the location classification can be generated by masking locations including bi-grams, not removing a stop word, and feature selection utilizing information gain. Such user geolocation information assists an enterprise marketing service and customer relationship management to understand the location related customer interest and sentiment for effective marketing and customer services.

FIG. 5 illustrates a high level flow chart of operations illustrating logical operational steps of a method 400 for extracting and classifying location information utilizing the social media messages 320, in accordance with the disclosed embodiments. Note that the method 400 can be implemented in the context of a computer-useable medium that contains a program product including, for example, a module or group of modules. Initially, the social media messages 320 can be sampled from the social media database 365 and the messages 320 can be filtered based on the heuristic rule, as indicated at block 410.

The messages can be filtered with keywords such as, for example, “news”, “nbc”, “cnn”, “deal”, “coupon”, “RT”, etc., in order to obtain enough percentage of the user location messages in the training data, reduce noisy data, and make human annotation efforts more effective. The messages posted by user names, for example, “realtor”, “realty”, “job”, “sports”, “.com”, “.org”, etc., and the messages with URLs (excluding check-in messages) which are related to content sharing and passing but much less related to the user locations can also be filtered. The percentage of the user location messages in the training data increases dramatically after the filtering process. Note that the filtering process can be conducted as preprocessing in the model training phase and the process can run on final location classifier on all the messages.

The geolocation entity can be extracted from the unstructured social media messages utilizing geographic entity extracting module 325, as shown at block 420. The extraction of geographical names from the unstructured text can be regarded as a sub-task of named entity recognition (NER) in natural language processing. The gazetteers and linguistic rules can be employed to extract the geolocation entity. Thereafter, as indicated at block 430, the messages with the geo-entities are uploaded onto the crowd sourcing platform (e.g., Amazon Mechanical Turk (AMT)) to manually annotate the messages with a label.

In general, AMT is a marketplace for human intelligence tasks (HITs), which includes types of users' providers and workers. The providers pay a small fee to post HITs on the AMT, which workers can search and complete to gain monetary payback. The providers can reject the work if they are not satisfied with the work quality criteria. For example, the HIT may contain 10 messages with geo entities and one of them may be a fake message that can be purposely planted as a way to automatically validate the worker quality by comparing it with the answer. Note that the AMT to obtain human labels and to train the location models as utilized herein is presented for general illustrative purposes only. It can be appreciated, however, that such embodiments can be implemented in the context of other systems and platforms without departing from the scope of the invention.

The text classification model can be built and learned from the human labels utilizing a machine learning algorithm and the messages can be classified by a location classifier module 340 in order to extract the user location, as depicted at block 440. The user location message can be categorized into “past”, “current”, and “future” classes. A machine learning algorithm can be employed to build the text classification models learned from the human labels. The accuracy of classifying the message can be improved by the location classifier module 340.

The features generated from some linguistic rules such as articles (a, an, the, etc.) preceding the location name, and prepositions (in, from, to, at, etc.) preceding the location name, etc., can also be included to represent that the user location identification and categorization are content dependent. Note the classification algorithms can be, for example, maximum entropy, Naive Bayes, and SVM to achieve the best performance and efficiency in testing. The maximum entropy aims to maximize the “uniformity” of the conditional probability of the class provided in the document while constraining the expected value of the features to be equal to the expected value of the features in the training data. That is, to maximize the entropy of the conditional probability distribution P(c|d) where d indicates the document, and c indicates the class. This can be formularized as shown in equation (1) below:

argmaxₚH(p)=argmax(−Σ_{c,d}p(d)p(c|d)log p(c|d)) (1)

The following constraints have to be satisfied when maximizing equation (1).

p(c|d)≧0 for all c,d. (2)

Σ_{c}p(c|d)=1 for all x. (3)

Σ_{c,d}p(d)p(c|d)f(c,d)=Σ_{c,d}p(d,c)f(c,d) (4)

wherein f(c,d) represents the features of the document d in class c. In order to avoid over fitting of maximum entropy, a Gaussian prior with mean 0 and variance 1 can be introduced. A Naive Bayes classifier is a simple probabilistic classifier based on applying Bayes' theorem with strong (naive) independence assumptions. A more descriptive term for the underlying probability model would be “independent feature model” which can be represented as shown in equation (5):

argmax_{c}P(c|d)=argmax_{c}P(d|c)P(c)=argmax_{c}P(f_{d1}|c)P(f_{d2}|c) . . . P(f_{dm}|c)P(c), (5)

wherein f_{dm} represents the feature m in document d. The multinomial Naive Bayes with Laplace smoothing can be employed to avoid zero probability. The support vector machine separates data mapped into a higher dimension space utilizing hyper-planes to maximize the margins from the “closest” points to the hyper-planes. It can be written as shown in equation (6) below:

$${min}_{w , b , ξ} \frac{1}{2} {w}^{T} w + C {\sum }_{i = 1}^{i} {ξ}_{i} \\ subject to {y}_{i} ( {w}^{T} φ ( {x}_{i} ) + b ) \geq 1 - {ξ}_{i} , \\ {ξ}_{i} \geq 0 , i = 1 , … , l , \qquad ( 6 )$$

The linear kernel for (xᵢ) can be chosen for fast training and testing. The cost C can be carefully chosen to obtain the best accuracy. Finally, the user location can then be transformed into the geocode so that spatial search can be enabled and the distance between the locations can be easily calculated, as shown at block 450. The text features can be generated by masking locations with @location, and mask mentions with @username to avoid bias towards some particular location names and user names. The classification algorithms biased toward some particular locations and user names can also be avoided. For example, “Liverpool” is often in non-user-location training messages because it often refers to a famous soccer team. The classification algorithms classify messages with “Liverpool” into non-user-location messages. Each feature is a word or bi-gram and the bi-grams can be included to increase accuracy by 4% in the user location messages identification task. The stop words removal (I, we, you, come, go . . . etc.) cannot be removed to increase the accuracy by 5%. The feature selection utilizing information gain also increases accuracy by 4%. The F-score can also be employed to choose the top features in order to generate very similar set of top features to information/gain.

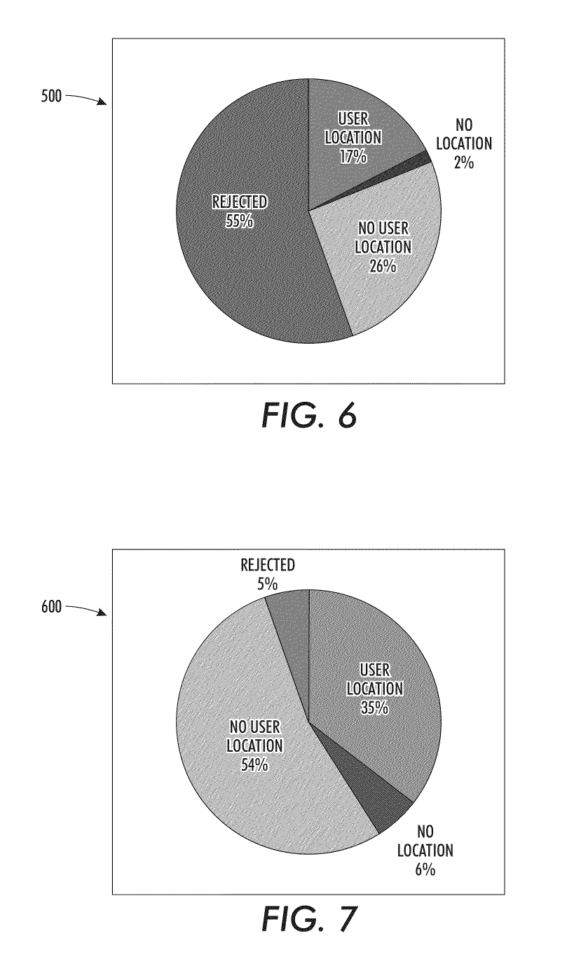

FIGS. 6-7 illustrate a graph 500 and 600 depicting data indicative of AMT labels with respect to the user location identification, in accordance with an exemplary embodiment. A random of 10,000 messages with geoentities on AMT is considered and each message is assigned to 3 annotators. For the first task to identify user location messages, if labels are obtained by 3 annotators all agreeing with each other, 55% percent of messages are rejected as illustrated in FIG. 6, 17% messages are user location messages, 26% messages are not user location messages, and 2% does not have locations. If labels are obtained by at least 2 annotators agreeing with each other, the result is shown in the FIG. 7. The AMT results show that the number of user location messages is significant compared to the number of user check-in locations. As seen from the data, 3,740,096 are English messages; where 28,693 has check-in locations. The number of messages containing geo entities after filtering is 47,216, so the number of user location messages is approximately 16,556. Note that this number is the lower bound as the re-messages, URL messages, and messages containing some key words are not considered. Hence the probability of user checking in the locations is quite similar to user messaging in the locations.

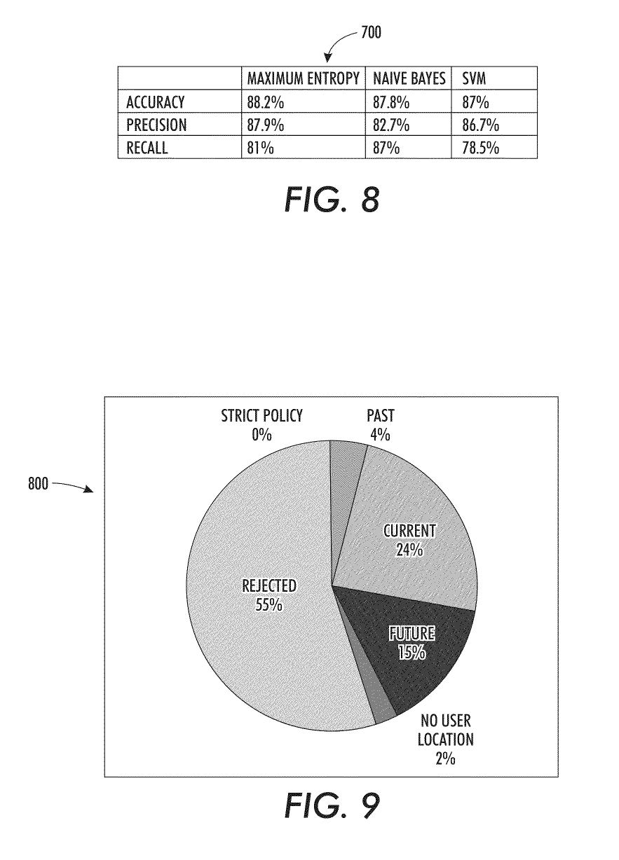

FIG. 8 illustrates a table 700 representing the classification performance with respect to the user location messages identification, in accordance with an exemplary embodiment. The maximum entropy, Naive Bayes, and SVM can be executed on the strict generated labels (all 3 annotators have to agree with each other). The accuracy, precision, and recall are reported in the table 700 utilizing 10-fold cross validation. The maximum entropy obtained the best accuracy 88.2%. Note that the SVM with radial basis function kernel can obtain 90% accuracy.

FIG. 9 illustrates a graph 800 depicting data indicative of AMT labels with respect to the user location categorization, in accordance with an exemplary embodiment. For the categorization of user location messages into “past”, “current”, and “future”, 3,582 user location messages on AMT can be posted to get human labels. FIG. 9 demonstrates the percentage of each category, where labels are obtained when 3 annotators agree with each other. The users tend to message their current and future locations much more than the past locations as shown in FIG. 9.

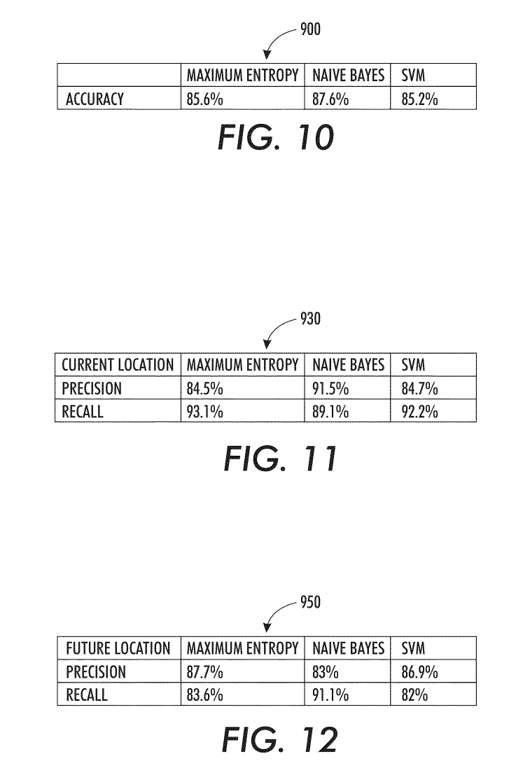

FIG. 10 illustrates a table 900 representing classification performance with respect to user location messages categorization, in accordance with an exemplary embodiment. FIGS. 11-12 illustrate a table 930 and 950 representing precision and recall of current location identification and future location identification, in accordance with an exemplary embodiment. The labels utilizing strict rule can be obtained and the experimental results utilizing 10-fold cross validation can be evaluated. Table 900, 930 and 950 represent the classification performance of user location messages categorization utilizing maximum entropy, Naive Bayes, and SVM. The accuracy is 87.6% utilizing Naive Bayes. The precision and recall of current/future location messages identification can be over 90% as shown in Table 930 and 950. The user geolocation information assists an enterprise marketing service and customer relationship management to understand the location related customer interest and sentiment for effective marketing and customer services.

Based on the foregoing, it can be appreciated that varying embodiments, preferred and alternative, are disclosed herein. For example, an embodiment can be implemented as a method for extracting and classifying user geolocation information. Such a method can include, for example, the steps of sampling a plurality of social media messages from a social media database in order to thereafter filter the plurality of social media messages based on a heuristic rule utilizing a heuristic message filtering module and generate at least one social media message filtered from the plurality of social media messages via the heuristic message filtering module, and extracting a geolocation entity from the at least one social media message utilizing a geolocation entity-extracting module. Such a method can further include steps for uploading the at least one message onto a crowd sourcing platform to manually annotate the at least one social media message with a label, and configuring and learning a text classification model from the label utilizing a machine-learning algorithm in order to thereafter classify the at least one social medial message by a location classifier and extract location data.

In other embodiments, a step can be provided for transforming the location data into a geocode in order to spatially search and calculate a distance between the locations. In yet other embodiments, a step can be provided for filtering the plurality of social media messages in order to obtain a plurality of location messages and to reduce noisy data. In still other embodiments, a step can be implemented for performing the geolocation entity extraction utilizing one or more of the following types of rules: a geographic dictionary or a linguistic rule.

In other embodiments, a step can be implemented for analyzing the plurality of user location messages in order to classify the plurality of user location messages into a past location, a current location, and a future location. In still other embodiments, the aforementioned machine learning algorithm can be, for example, one or more of the following types of algorithms: a maximum entropy; Naive Bayes, and a support vector machine. In yet other embodiments, a step can be implemented for generating a text feature for the location classification by masking the location and including a bi-gram. In still other embodiments, a step can be implemented for generating a text feature for the location classification by not removing a stop word and including a feature selection utilizing an information gain.

In other embodiments, a system can be implemented for extracting and classifying user geolocation information. Such a system can include, for example, a processor, and a data bus coupled to the processor. Such a system can further include a computer-usable medium embodying computer code, the computer-usable medium being coupled to the data bus. Such computer program code can include, for example, instructions executable by the processor and configured for sampling a plurality of social media messages from a social media database in order to thereafter filter the plurality of social media messages based on a heuristic rule utilizing a heuristic message filtering module and generate at least one social media message filtered from the plurality of social media messages via the heuristic message filtering module, and extracting a geolocation entity from the at least one social media message utilizing a geolocation entity-extracting module. Such instructions can be further configured for uploading the at least one message onto a crowd sourcing platform to manually annotate the at least one social media message with a label; and configuring and learning a text classification model from the label utilizing a machine-learning algorithm in order to thereafter classify the at least one social medial message by a location classifier and extract location data.

In other embodiments, such instructions can be further configured for transforming the location data into a geocode in order to enable a spatial search and calculate a distance between the locations. In still other embodiments, such instructions can be further configured for filtering the plurality of social media messages in order to obtain a plurality of location messages and to reduce noisy data. In yet other embodiments, such instructions can be further configure for performing the geolocation entity extraction utilizing one or more of the following types of rules: a geographic dictionary or a linguistic rule. In other embodiments, such instructions can be configured for analyzing the plurality of user location messages in order to classify the plurality of user location messages into a past location, a current location, and a future location.

In yet other embodiments, the aforementioned machine-learning algorithm can be one or more of the following types of algorithms: a maximum entropy; Naive Bayes; and a support vector machine. In still other embodiments, such instructions can be configured for generating a text feature for the location classification by masking the location and including a bi-gram. In still other embodiments, such instructions can be further configured for generating a text feature for the location classification by not removing a stop word and including a feature selection utilizing an information gain.

In yet other embodiments, a processor-readable medium can be implemented for storing code representing instructions to cause a processor to perform a process to extract and classify user geolocation information. Such code can include, for example, code to sample a plurality of social media messages from a social media database in order to thereafter filter the plurality of social media messages based on a heuristic rule utilizing a heuristic message filtering module and generate at least one social media message filtered from the plurality of social media messages via the heuristic message filtering module; extract a geolocation entity from the at least one social media message utilizing a geolocation entity-extracting module; upload the at least one message onto a crowd sourcing platform to manually annotate the at least one social media message with a label; and configure and learn a text classification model from the label utilizing a machine-learning algorithm in order to thereafter classify the at least one social medial message by a location classifier and extract location data.

In other embodiments, such code can include code to transform the location data into a geocode in order to enable a spatial search and calculate a distance between the locations. In still other embodiments, such code can include code to filter the plurality of social media messages and therefore obtain a plurality of location messages and to reduce noisy data. In other embodiments, code can include code to perform the geolocation entity extraction utilizing at least one of the following types of rules: a geographic dictionary or a linguistic rule.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for extracting and classifying user geolocation information, said method comprising:
sampling a plurality of social media messages comprising text, from a social media database in order to thereafter filter said plurality of social media messages based on a heuristic rule utilizing a heuristic message filtering module and generate at least one social media message filtered from said plurality of social media messages via said heuristic message filtering module;
extracting a geolocation entity from said at least one social media message utilizing a geolocation entity-extracting module;
uploading said at least one message onto a crowd sourcing platform to manually annotate said at least one social media message with a label; and
training a text classification model from said label utilizing a machine-learning algorithm in order to thereafter classify said at least one social medial message by a location classifier and extract location data.

2. The method of claim 1 further comprising transforming said location data into a geocode in order to enable a spatial search and calculate a distance between said locations.

3. The method of claim 1 further comprising filtering said plurality of social media messages in order to obtain a plurality of location messages and to reduce noisy data.

4. The method of claim 1 further comprising performing said geolocation entity extraction utilizing at least one of the following types of rules: a geographic dictionary.

5. The method of claim 1 further comprising analyzing said plurality of user location messages in order to classify said plurality of user location messages into a past location, a current location, and a future location.

6. The method of claim 1 wherein said machine learning algorithm comprises at least one of the following types of algorithms: a maximum entropy; Naive Bayes; and a support vector machine.

7. The method of claim 1 further comprising generating a text feature for said location classification by masking said location and including a bi-gram.

8. The method of claim 1 further comprising generating a text feature for said location classification by not removing a stop word and including a feature selection utilizing an information gain.

9. A system for extracting and classifying user geolocation information, said system comprising:
a processor;
a data bus coupled to said processor; and
a computer-usable medium embodying computer code, said computer-usable medium being coupled to said data bus, said computer program code comprising instructions executable by said processor and configured for:
sampling a plurality of social media messages comprising text, from a social media database in order to thereafter filter said plurality of social media messages based on a heuristic rule utilizing a heuristic message filtering module and generate at least one social media message filtered from said plurality of social media messages via said heuristic message filtering module;
extracting a geolocation entity from said at least one social media message utilizing a geolocation entity-extracting module;
uploading said at least one message onto a crowd sourcing platform to manually annotate said at least one social media message with a label; and
training a text classification model from said label utilizing a machine-learning algorithm in order to thereafter classify said at least one social medial message by a location classifier and extract location data.

10. The system of claim 9 wherein said instructions are further configured for transforming said location data into a geocode in order to enable a spatial search and calculate a distance between said locations.

11. The system of claim 9 wherein said instructions are further configured for filtering said plurality of social media messages in order to obtain a plurality of location messages and to reduce noisy data.

12. The system of claim 9 wherein said instructions are further configured for performing said geolocation entity extraction utilizing at least one of the following types of rules: a geographic dictionary.

13. The system of claim 9 wherein said instructions are further configured for analyzing said plurality of user location messages in order to classify said plurality of user location messages into a past location, a current location, and a future location.

14. The system of claim 9 wherein said machine learning algorithm comprises at least one of the following types of algorithms: a maximum entropy; Naive Bayes; and a support vector machine.

15. The system of claim 9 wherein said instructions are further configured for generating a text feature for said location classification by masking said location and including a bi-gram.

16. The system of claim 9 wherein said instructions are further configured for generating a text feature for said location classification by not removing a stop word and including a feature selection utilizing an information gain.

17. A processor-readable medium storing code representing instructions to cause a processor to perform a process to extract and classify user geolocation information, said code comprising code to:
sample a plurality of social media messages comprising text, from a social media database in order to thereafter filter said plurality of social media messages based on a heuristic rule utilizing a heuristic message filtering module and generate at least one social media message filtered from said plurality of social media messages via said heuristic message filtering module;
extract a geolocation entity from said at least one social media message utilizing a geolocation entity-extracting module;
upload said at least one message onto a crowd sourcing platform to manually annotate said at least one social media message with a label; and
train a text classification model from said label utilizing a machine-learning algorithm in order to thereafter classify said at least one social medial message by a location classifier and extract location data.

18. The processor-readable medium of claim 17 further comprises code to transform said location data into a geocode in order to enable a spatial search and calculate a distance between said locations.

19. The processor-readable medium of claim 17 further comprises code to filter said plurality of social media messages in order to obtain a plurality of location messages and to reduce noisy data.

20. The processor-readable medium of claim 17 further comprises code to perform said geolocation entity extraction utilizing at least one of the following types of rules: a geographic dictionary.
